(19) United States
(12) Patent Application Publication
(10) Pub. No.: US 2002/0172323 A1
(43) Pub. Date: Nov. 21, 2002

(54) Device for detection of extravasation

(75) Inventors: Andrew Karellas, Auburn, MA (US); Michael A. Davis, Sharon, MA (US)

Correspondence Address: THOMAS O. HOOVER, ESQ., BOWDITCH & DEWEY, LLP, 161 Worcester Road, P.O. Box 9320, Framingham, MA, 01701-9320, US

(73) Assignee: University of Massachusetts Medical Center, Worcester, MA (US)

(21) Appl. No.: 10/062,284

(22) Filed: Feb. 1, 2002

Related U.S. Application Data
(60) Provisional application No. 60/266,391, filed on Feb. 2, 2001.

(51) Int. Cl. G01F 1/66; G01N 23/06

(52) U.S. Cl. 378/51

(57) ABSTRACT

The present invention involves imaging systems for the detection of extravasation. A pixellated detector is preferably used to detect and control the injection of contrast agents or medications used in a variety of diagnostic or therapeutic procedures.

### CROSS REFERENCES TO RELATED APPLICATIONS

The application claims the benefit of U.S. Provisional Application No. 60/266,391, filed Feb. 2, 2001. The entire contents of the above application is being incorporated herein by reference.

### BACKGROUND OF THE INVENTION

X-ray imaging examinations provide planar or tomographic representation of anatomy and function by virtue of the differential attenuation of various tissues. There are situations, however, where the absorption between different tissues is very subtle, and the contrast between these tissues is either difficult or impossible to discern without the injection of an x-ray absorbing agent (e.g. contrast media or CM). This is particularly the case in planar angiographic examinations, cardiac catheterization, and contrast-enhanced computed tomography (CT) examinations. The contrast enhancement of blood and tissue is generally achieved by an intravenous injection of an iodinated compound. In recent years, techniques have been developed for the rapid injection of the CM by using an automatic injection system. The use of these programmable injectors is extremely important in achieving a bolus of CM and, therefore, minimizing the premature dilution of the injected CM. Power injectors are now used routinely for virtually all CT examinations where CM is indicated, and they are also used widely in other angiographic applications. In some imaging protocols, particularly those using dynamic spiral CT techniques, the use of a power injector is essential for an optimal imaging study. Power injection techniques of CM are generally safe and effective, however, extravasation of CM is not an uncommon occurrence.

The term “extravasation” in the context is used to describe the leakage of contrast material outside the vasculature at or near the site of injection. A small amount of extravasation, typically less than 20 ml is not considered serious but a larger amount of CM leakage outside of the vasculature is highly undesirable and can cause tissue reaction in varying degrees. The result may be a mild reaction or, in some cases, severe injury can result with extensive subcutaneous tissue damage. In extreme cases, plastic surgery and tissue grafting may be necessary to repair the damage. The incidence rate of significant extravasation is slightly less than 1% of all CT examinations, which require power injection of CM. Although this seems to be a small fraction of the number of cases in a CT facility in a medium-sized hospital, one may expect to encounter approximately one case per month. Even in cases where a catastrophic event does not occur, discomfort to the patient from significant extravasation is a serious matter, and in case of severe tissue reaction, substantial injury to the patient can occur.

Existing techniques that attempt to address the problem of contrast extravasation involve prompt detection during the injection process. Virtually all of these techniques rely on either optical radiation techniques or the measurement of tissue impedance for the detection of early extravasation. Optical techniques for the detection of extravasation present many challenges. It is possible to detect extravasation by the transmission of infrared or radiofrequency radiation through the tissue, however the practical implementation of these techniques has not been successful. The only commercially available device is a system which uses tissue electrical impedance. This is a non-imaging approach and employs a patch and electrodes, which are placed on the patient's skin. If there is significant extravasation, a change in tissue impedance will occur, and the operator of the equipment will be alerted and the injection interrupted. This method relies on the monitoring of an oscilloscope-like signal, which can be interfaced to an alarm device, which can alert the operator. The tissue impedance increases during extravasation of an ionic CM, and it decreases as the result of extravasation of a non-ionic CM. The major disadvantages of the impedance technique are that the impedance baseline may be difficult to establish; variations in skin temperature, moisture, amount of subcutaneous fat may affect the impedance; there is a different response between ionic and non-ionic CM; contact with the skin is required; and the method does not provide an image and consequently may be more difficult to interpret.

A continuing need exists for improvements in detecting and avoiding extravasation that occurs during the injection of agents into the human body.

### SUMMARY OF THE INVENTION

The present invention relates to systems for the detection of extravasation during the injection of material for diagnoses or treatment. A preferred embodiment of the invention utilizes an energy source and a detector device to collect a spatially distributed energy pattern to provide a two dimensional representation of a region of interest at an injection site. The two dimensional representation can be used to generate an image of the region of interest which a user can view to monitor the injection sequence. The user can control or interrupt the injection to reduce extravasation in the event that it is detected. The representation or image can also be processed automatically to alert the user that extravasation is occurring or can automatically reduce the injection rate or terminate injection.

A preferred embodiment of the invention employs an x-ray source and detector that generates a coarse image matrix for low radiation dose and, a pixel binning method for low radiation dose and high signal-to-noise ratio. This system provides the user with the ability to outline veins, arteries (blood vessels) or lumens with fiducial markers to provide visualization of extravasated CM or other injected material such as chemotherapeutic agents. This provides an electronically recorded bounding within which the agent is to be confined. The system includes a trigger system to terminate injection by using a digital image matrix rather than analog or digital non-image signals. An acquired image can be compared using an image processor to a reference image obtained prior to injection. The software module controlling the comparison can be programmed to automatically stop the injection once a selected number of pixels within the region of interest has been altered by the intrusion of CM. A controller that receives a signal from the image processor sends a signal to the injector motor to interrupt the injection sequence. The user can also be notified by a visual and/or aural indicator such as a light or sound that the injection should be manually interrupted.

An x-ray or ultrasound source can be actuated by the controller to acquire as reference image or images and to initiate periodic or video imaging and recording of the injection sequence at the needle insertion site. A preferred embodiment is a compact device that has no radiation shielding requirements.

The methods employed in operating the system provide fast detection of extravasation through an imaging-based method using very low-dose x-rays to detect the absorption profile of the lumen or vessel and the surrounding area. It is possible to detect extravasation by using conventional x-ray fluoroscopic equipment; however, this approach is very expensive, and impractical. Currently available x-ray fluoroscopic equipment is not designed for this particular task, and they do not incorporate specific programming requirements for detection of extravasation. Moreover, they are not equipped with a triggering mechanism to stop the injector if extravasation is detected. In addition, all current fluoroscopic equipment is designed to deliver relatively high spatial resolution with is not necessary for the detection of extravasation. The proposed device employs a relatively coarse matrix of detecting elements which may not be suitable for other diagnostic x-ray examinations but is suitable for the visualization of extravasation of CM.

### BRIEF DESCRIPTION OF THE DRAWINGS

FIG. 1 is a schematic cross-sectional view of the system for imaging the injection of fluid in accordance with the invention.

FIG. 2 is a schematic illustration of another preferred embodiment of the invention.

FIG. 3 is a preferred embodiment of the invention using a fiberoptic taper.

FIG. 4 is a preferred embodiment of the invention using a lens system to reduce the size of the image for detection.

FIG. 5 illustrates an embodiment of the invention in which the area of the detector provides for imaging of the entire cross-section of the arm or leg of the patient being imaged.

FIG. 6 schematically illustrates a pixellated device for imaging a vein during contrast media injection.

FIGS. 7A, 7B and 7C illustrate embodiments using smaller detectors to image around or transverse to the vein or body lumen.

FIGS. 8A and 8B illustrate a preferred embodiment of the invention using an ultrasound system to detect extravasation.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

### DETAILED DESCRIPTION OF THE INVENTION

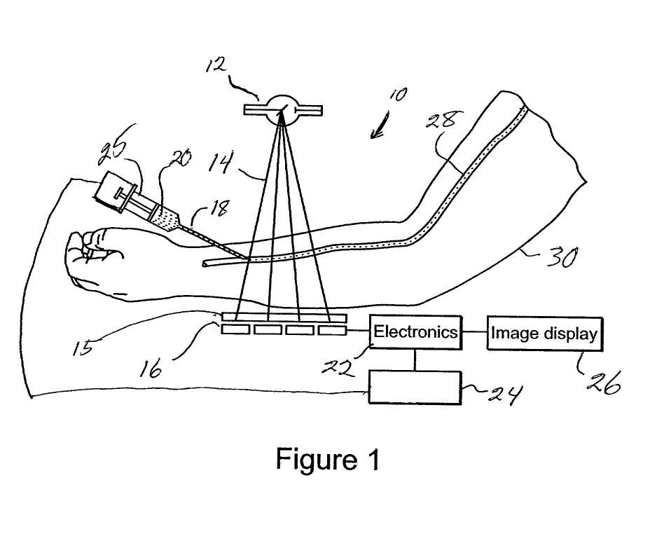

A system 10 for detecting extravasation is illustrated in FIG. 1 and includes an x-ray source 12 and a flat-panel detector 16 which are used for a preferred embodiment of the invention. The x-ray source 12 can be a very compact x-ray tube, which can be even smaller than a dental-type x-ray tube. The detector 16 can be either a charge-coupled device (CCD), amorphous silicon, C-MOS, or amorphous selenium detector. Other imaging flat-panel technologies such as x-ray sensitive pixellated semiconductors, cadmium zinc telluride or cadmium telluride detectors can also be used. In the case of a CCD, amorphous silicon, and C-MOS devices, for example, a scintillator 15 is placed on the top of the flat-panel detector and acts as the primary detector of x-rays. X-rays interact with the scintillator 15 and produce light, and the flat-panel detector 16 detects the scintillation light. In the case of an amorphous selenium detector, a scintillator is not necessary, the amorphous selenium may be made of significant thickness, typically one millimeter, to achieve respectable quantum efficiency (approximately 60%). The x-ray detection device is capable of running typically from one frame per second to seven frames per second. An electronic controller or data processor 22 is connected to the detector 16 to receive image data and control detector operation. The processor 22 can be connected to a separate controller 24 for the injector 25 to control the amount and rate of injection of liquid 20 through needle 18, or can directly control the injector 25. A real-time image is displayed with display 26 continuously during this acquisition. The technologist will have immediate image feedback as the CM or medication flows into the vein 28 of the patient 30 as a result of the injection. Even a small amount of CM extravasation can be easily detectable by the observer who can either manually interrupt the power injector or allow the automatic interruption system to engage. The x-ray beam can be confined to a relatively small area of the arm, typically 10×10 cm or smaller. One pre-exposure produces visualization of the radiopaque needle. Small linear wire-like markers may be placed parallel to each side of the vein in order to identify the location of the vein in the image. A pre-injection of a very small amount of the CM can also be used to identify the vein location.

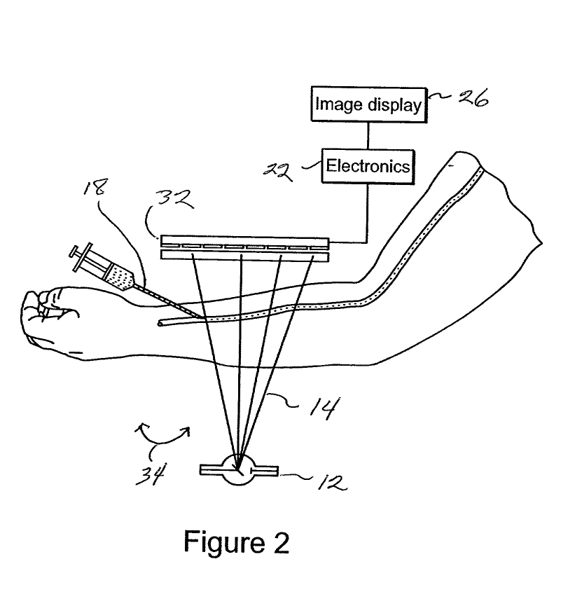

FIG. 2 shows the another embodiment of the invention using a different orientation of the x-ray projection system. The detector 32 and source 12 can be mounted in a housing that provides for rotation 34 around the arm to optimize viewing angle.

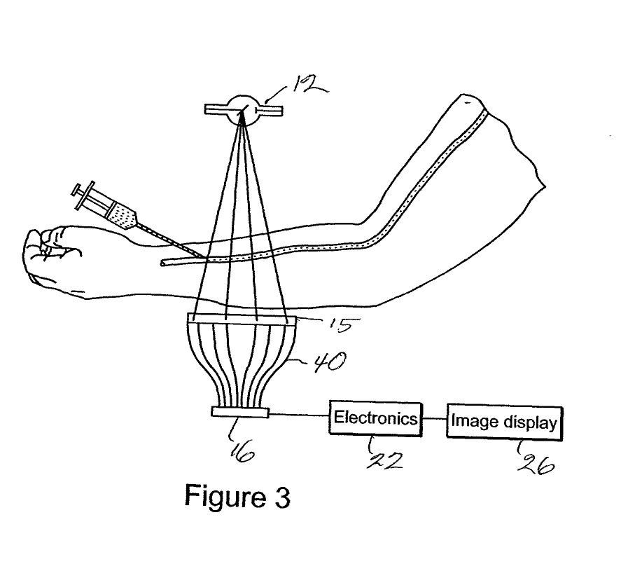

FIG. 3 shows a preferred system with a scintillator, fiberoptic taper 40 and a CCD or C-MOS sensor. Since CCDs have a spatial resolution which is much higher than what is actually needed, the CCD sensor can be binned (grouping adjacent pixels prior to readout). This results in a higher signal-to-noise ratio and lower radiation dose at the expense of spatial resolution; however, spatial resolution is not very important in this application. Even 1×1 mm or 2×2 mm pixels are adequate for the detection of extravasation. More details regarding detectors used in connection with the present invention are described in U.S. Pat. No. 6,031,892, the entire contents of which is incorporated herein by reference.

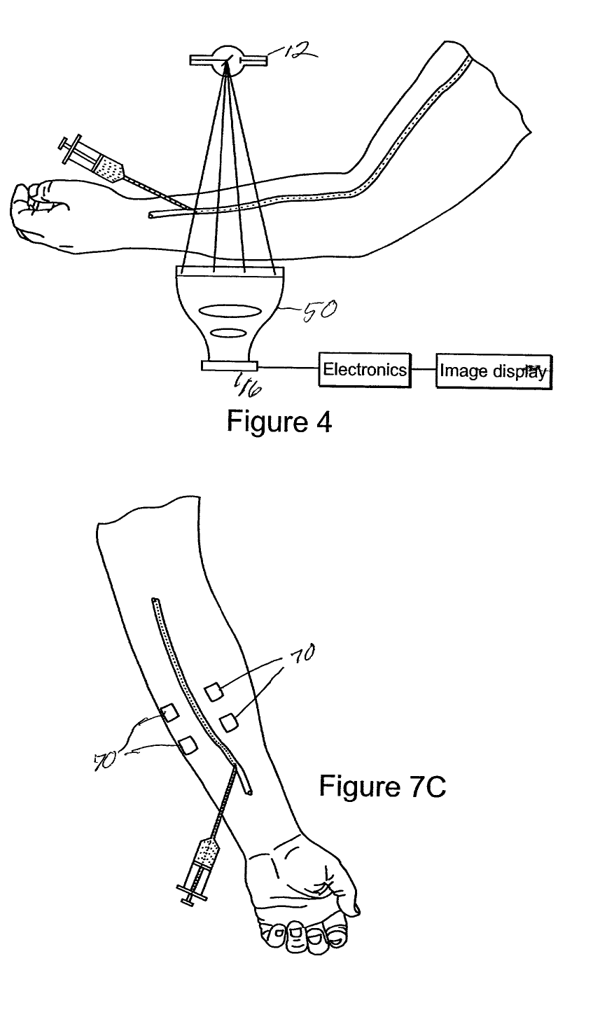

FIG. 4 illustrates an embodiment using a high numerical aperture lens or lens system 50 to reduce the size of the image for detection.

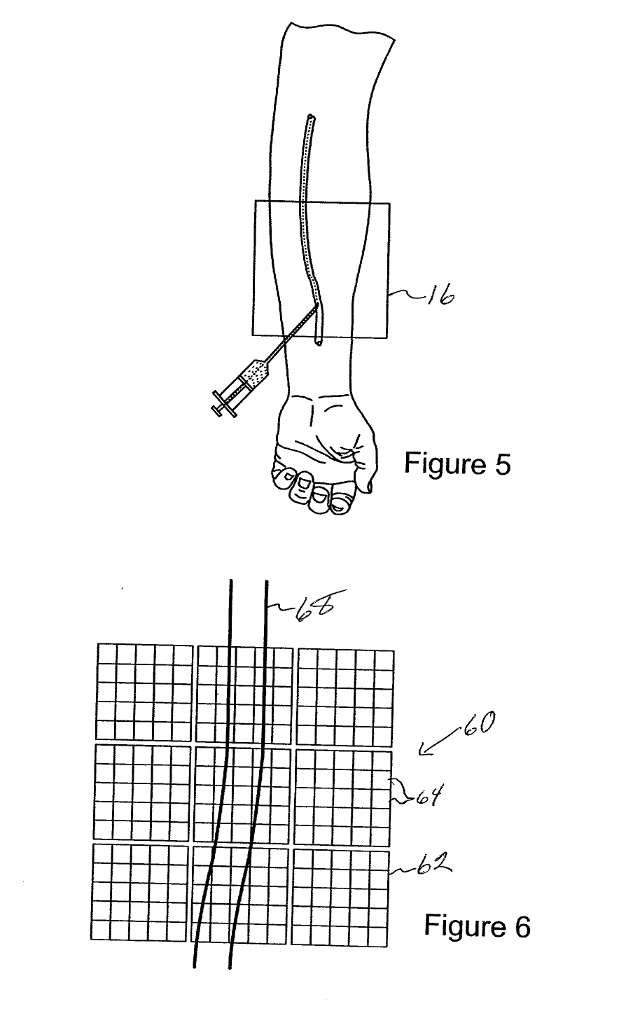

FIG. 5 shows the approximate location of the detector 16 over the injection area. The detector does not need to be as large as shown but can be reduced to reflect the likely area in which extravasation is likely to occur.

FIG. 6 illustrates a matrix of 3×3 detectors 60, and each detector 62 consists of a matrix of 5×5 detector elements 64. This detector matrix may be nine CCDs, nine C-MOS modules, or other silicon-based sensor for example. Other detectors include cadmium telluride or cadmium zinc telluride solid state or array detectors. In an alternative approach, a position-sensitive photomultiplier tube or array of conventional tubes can be used. If a photodetector is used which does not detect x-rays directly, a scintillator must be used on the top of this detector array. Another alternative is to employ avalanche photodiodes or a segmented avalanche photodiode with a scintillator. Another preferred embodiment uses an x-ray sensitive pixellated semiconductor detector. It can be seen in FIG. 6 that relatively coarse detector elements are more than adequate to detect extravasation around artery or vessel 68.

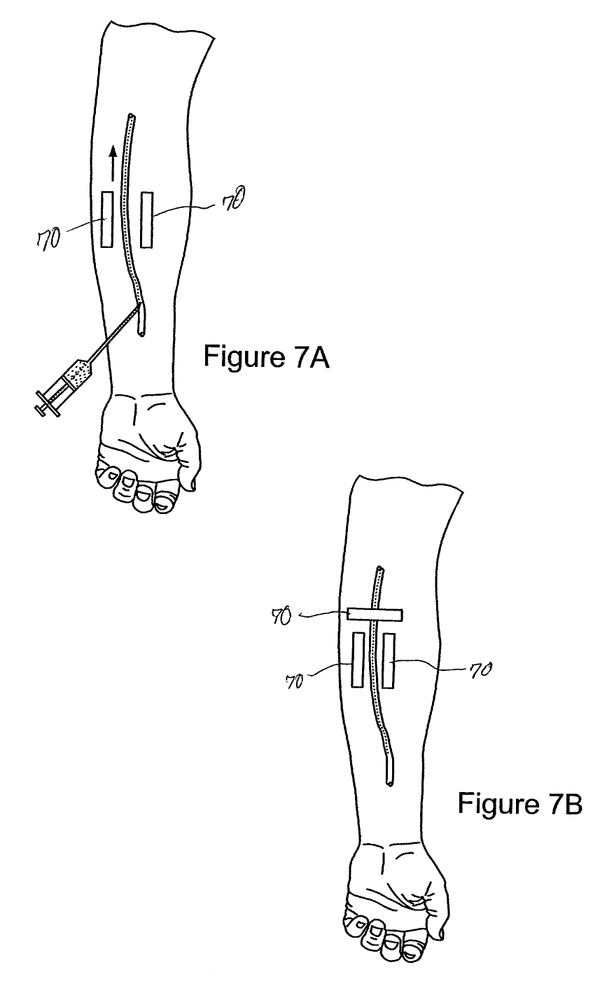

FIGS. 7A, 7B and 7C illustrate additional embodiments where x-ray or other detector elements 70 may be placed around the vein for the detection of extravasation. A baseline exposure may be taken initially, and during the injection, the signal or image generated from the detectors may be monitored. If extravasation detection does not occur, the signal on the x-ray detectors running parallel to the vein should not change appreciably from the baseline. If there is extravasation, contrast material flows between the x-ray source and the detector and causes a reduction in the x-ray signal in tissue beyond the vein or lumen in which the CM should be confined, which is consequently detected by the x-ray detector. The interruption of the injection may be made either manually by the observer or by an automatic control system within controller 22 as described previously in connection with the other embodiments.

The method of using the invention involves positioning the extravasation monitoring device (EMD) at the side of the patient during injection. The patient's arm is placed on the device and the operator visually identifies the vein (no x-rays in use) and inserts the needle. Two linear radio-opaque markers approximately 2 cm length are secured on the skin on each side of the vein (the markers have adhesive on one side and they adhere to the skin). The device is activated briefly to produce a low dose image of the needle, and markers. This image is stored as the reference image. The computer maps the approximate area of the image which is occupied by the vein and identifies detector elements on the outside of the linear markers. The operator activates the CT scanner, the power injector and the EMD. The EMD acquires images at a predetermined frame rate during the process, typically from 1 to 7 per second. Each image is automatically compared with the reference pixels outside the markers. If the detected signal drops below a predetermined level, it will be due to extravasated contrast material in the path of the x-ray beam. If the signal drops below a predetermined level the EMD triggers the injector to terminate the injection. Alternatively, the operator may monitor the x-ray image for extravasation and make the decision on a combination of what is observed with the calculated value of signal drop which can also be displayed.

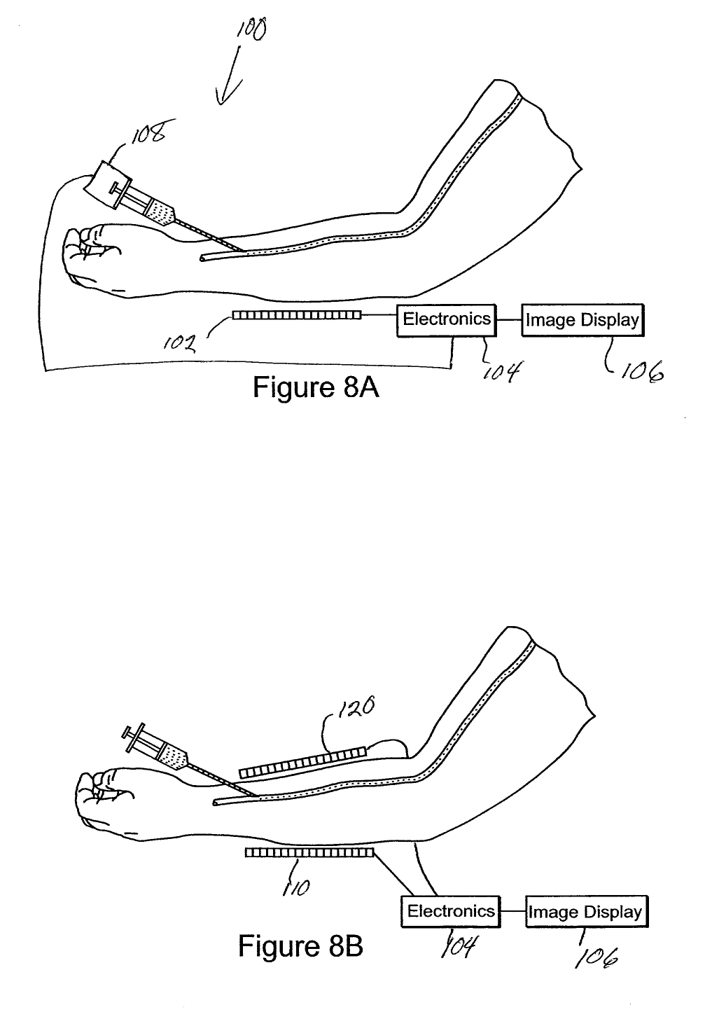

An ultrasound system 100 for the detection of contrast extravasation is another preferred embodiment of the invention illustrated in FIGS. 8A and 8B. Doppler-based, pulse-echo, or transmission based methods can be used in this method of image acquisition. For example, an ultrasound transducer array 102 operating in a pulse echo mode can be brought into contact with the skin of the patient overlying the region of interest. A controller or data processor 104 controls the array 102 and performs beamforming, scan conversion and other image processing operations and the images or video sequence displayed on display 106. The image processor of the ultrasound system can be programmed as described above, or the user can simply observe the region of interest during injection. As described in connection with previous embodiments, the controller can be connected directly to a motorized injector to control initiation, delivery rate and interruption of delivery. Also a phased array type, multielement transducer or a number of single element transducers can also be used. Alternatively, as shown in FIG. 8B, the transducer system can be used in transmission mode including emitters 110 and receivers 120. Frequencies can be in the range of 0.5 to 15 MHz, preferably less than 5 MHz can be used.

While this invention has been particularly shown and described with references to preferred embodiments thereof, it will be understood by those skilled in the art that various change in form and details may be made therein without departing from the scope of the invention encompassed by the appended claims.

What is claimed:

1. A device for the detection of extravasation comprising:
an imaging detector;
an injector; and
a processor that receives image data from the detector.

2. The device of claim 1 further comprising an energy source that directs energy at the detector.

3. The device of claim 2 wherein the energy source comprises an x-ray radiation source.

4. The device of claim 2 wherein the energy source comprises an ultrasound transducer array.

5. The device of claim 1 wherein the detector comprises an x-ray detector.

6. The device of claim 1 wherein the processor is connected to an injector.

7. A method for controlling an injection of a material comprising:
injecting a material into a lumen at an injection site;
forming an image of a region of interest including the injection site;
indicating intrusion of the material beyond a lumen boundry; and
altering an injection rate of the material in response to the indicated intrusion.

8. The method of claim 7 further comprising injecting a contrast agent for an imaging procedure into the lumen of a patient.

9. The method of claim 7 further comprising providing an x-ray source and an x-ray detector.

10. The method of claim 7 further comprising providing an ultrasound imaging system.

11. The method claim 7 further comprising providing an ultrasound transducer array connected to a data processor, an imaging device and an automated injector.

12. The method of claim 7 further comprising conducting a CT examination of a patient.

13. The method of claim 9 wherein the detector comprises a scintillator coupled to pixellated detector.

14. The method of claim 7 wherein the step of forming an image comprises detecting x-rays transmitted through a region of interest of the patient with an x-ray sensitive pixellated flat panel detector.

15. A device for the detection of extravasation comprising:
an x-ray source;
an imaging detector;
an automated injector; and
a processor that receives image data from the detector.

16. The device of claim 15 further comprising the x-ray source directs x-rays onto the detector having a two dimensional array of pixels.

17. The device of claim 15 wherein the detector is coupled to a scintillator with a fiber optic coupler.

18. The device of claim 2 wherein the detector comprises amorphous silicon.

19. The device of claim 1 wherein the detector comprises a change coupled device.

20. The device of claim 1 wherein the processor is connected to the injector.
